(19) United States
(12) Patent Application Publication
(10) Pub. No.: US 2016/0323542 A1
(43) Pub. Date: Nov. 3, 2016

(54) USER TERMINAL DEVICE AND METHOD FOR PROVIDING INTERACTION SERVICE THEREFOR

(71) Applicant: SAMSUNG ELECTRONICS CO., LTD., Suwon-si (KR)

(72) Inventors: Hye-soo KIM, Suwon-si, Gyenoggi-do (KR); Youn-gun JUNG, Suwon-si, Gyenoggi-do (KR)

(21) Appl. No.: 15/104,364

(22) PCT Filed: Dec. 16, 2013
(86) PCT No.: PCT/KR2013/011685

§ 371 Date: Jun. 14, 2016

(51) Int. Cl. H04N 7/14; G06F 3/14; H04N 21/4788; H04N 21/41; H04N 21/4223

(52) U.S. Cl. CPC H04N 7/141; H04N 21/4126; H04N 21/4223; H04N 21/4788; G06F 3/1454

(57) ABSTRACT

A method for providing an interaction service of a user terminal device is disclosed. The method for providing an interaction service comprises the steps of: executing a video call service with a counterpart device; searching for a peripheral device to be used as a data input source with respect to the video call service; receiving video call data from at least one peripheral device among the detected peripheral devices; and transmitting the received video call data to the counterpart device.

### TECHNICAL FIELD

The present invention relates to a user terminal device and a method for providing an interaction service therefor, and more particularly, to a user terminal device which provides a video call service or a screen sharing service and a method for providing an interaction service therefor.

### BACKGROUND ART

Due to the development of electronic technology, various types of electronic devices have been developed and propagated. In particular, user terminal devices based on the excellent IT technology, such as state-of-the-art smart phones, have been propagated.

The state-of-the-art user terminal devices tend to have a camera function, a microphone function, and the like. Accordingly, the state-of-the-art user terminal devices provide a video call service capable of using the camera function, the microphone function, and the like.

However, the typical video call service is executed by imaging an image through a fixed camera. Accordingly, a video call participant may receive the video call service only in response to the participant is located just in front of the video calling device.

Therefore, there is a problem in that mobility of the video call participant is restricted in the related art.

### DETAILED DESCRIPTION OF THE INVENTION

### Technical Problem

The present invention has been made in view of the above problems, and an object of the present invention is to provide a user terminal device which provides an interaction service by switching a data input source with respect to the interaction service to data received from a peripheral device and a method for providing an interaction service therefor.

### Technical Solution

To obtain the above-described object, the present invention is to provide an interaction service providing method of a user terminal device, the method including the steps of executing a video call service with a counterpart device, searching for peripheral devices to be used as a data input source with respect to the video call service, receiving video call data from at least one peripheral device among the searched peripheral devices, and transmitting the received video call data to the counterpart device.

The method may further include the steps of displaying the searched peripheral devices, and receiving selection for a peripheral device to be used as the data input source with respect to the video call service among the displayed peripheral devices. The step of receiving may include the step of receiving the video call data from the selected peripheral device.

The method may further include the steps of in response to the peripheral device being selected, displaying data types providable in the selected peripheral device, and receiving selection for at least one data type among the displayed data types. The step of receiving may include the step of receiving the video call data corresponding to the selected data type.

The data type may include at least one among a multimedia data type pre-stored in the peripheral device, an image data type imaged in real time in the peripheral device, and a voice data type received in real time in the peripheral device.

The method may further include the step of determining a communication method between the user terminal device and the selected peripheral device to a real time transmission method or a streaming method using wired/wireless information of a communication network formed between the user terminal device and the selected peripheral device and size information of video call data to be received from the selected peripheral device.

The method may further include, in response to the transmission method being determined as the streaming method, the step of performing negotiation on the peripheral device so that session information for the determined streaming method is corresponding to session information with respect to the video call service between the user terminal device and the counterpart device.

The method may further include the step of displaying a video call service screen including the video call data received from the selected peripheral device.

To obtain the above-described object, the present invention is to provide a user terminal device which executes a video call service with a counterpart device, the user terminal device including a searching unit which searches for peripheral devices to be used as a data input source with respect to the video call service, a communication unit which receives video call data from at least one peripheral device among the searched peripheral devices, and a control unit which controls the communication unit to transmit the received video call data to the counterpart device.

The user terminal device may further include a display unit which displays the searched peripheral devices and an input unit which receives selection for a peripheral device to be used as the data input source with respect to the video call service among the displayed peripheral devices. The control unit may control the communication unit to receive the video call data from the selected peripheral device.

The display unit may display, in response to the peripheral device being selected, data types providable in the selected peripheral device, and the input unit may receive selection for at least one data type among the displayed data types. The control unit may control the communication unit to receive the video call data corresponding to the selected data type.

The data type may include at least one among a multimedia data type pre-stored in the peripheral device, an image data type imaged in real time in the peripheral device, and a voice data type received in real time in the peripheral device.

The control unit may determine a communication method between the user terminal device and the selected peripheral device to a real time transmission method or a streaming method using wired/wireless information of a communication network formed between the user terminal device and the selected peripheral device and size information of video call data to be received from the selected peripheral device.

In response to the transmission method being determined as the streaming method, the control unit may control the communication unit to perform negotiation on the peripheral device so that session information for the determined streaming method is corresponding to session information with respect to the video call service between the user terminal device and the counterpart device.

The user terminal device may further include a display unit which displays a video call service screen including the video call data received from the selected peripheral device.

To obtain the above-described object, the present invention is to provide an interaction service providing method of a user terminal device, the method including the steps of executing a screen sharing service with a counterpart device, searching for peripheral devices to be used as a data input source with respect to the screen sharing service, receiving selection for at least one peripheral device among the searched peripheral devices, receiving first screen data from the selected at least one peripheral device, and transmitting the received first screen data to the counterpart device.

The method may further include the step of displaying a screen sharing service screen corresponding to the first screen data received from the selected at least one peripheral device.

The method may further include the steps of receiving a user input which operates the displayed screen sharing service screen, transmitting location information corresponding to the received user input to the selected at least one peripheral device, receiving, in response to a screen in the selected at least one peripheral device being switched according to the transmission of the location information, second screen data corresponding to the switched screen, transmitting the second screen data to the counterpart device, and displaying a screen sharing service screen corresponding to the second screen data.

The first screen data and the second screen data may be data generated through capture of a screen currently displayed in the selected at least one peripheral device.

To obtain the above-described object, the present invention is to provide a user terminal device which executes a screen sharing service, the user terminal device including a searching unit which searches for peripheral devices to be used as a data input source with respect to the video call service, an input unit which receives selection for at least one peripheral device among the searched peripheral devices, a communication unit which receives first screen data from the selected at least one peripheral device, and a control unit which controls the communication unit to transmit the received first screen data to a counterpart device.

The user terminal device may further include a display unit which displays a screen sharing service screen corresponding to the first screen data received from the selected at least one peripheral device.

The input unit may receive a user input which operates the displayed screen sharing service screen. The communication unit may transmit location information corresponding to the received user input to the selected at least one peripheral device, and in response to a screen in the selected at least one peripheral device being switched according to the transmission of the location information, the communication unit may receive second screen data corresponding to the switched screen. The control unit may control the communication unit to transmit the second screen data to the counterpart device and control the display unit to display a screen sharing service screen corresponding to the second screen data.

The first screen data and the second screen data may be data generated according to capture of a screen currently displayed in the selected at least one peripheral device.

### Effect of the Invention

According to the above-described video call system according to an embodiment of the present invention, a video call participant who executes a video call service in front of a digital TV may continuously execute the video call service while moving to another space using a portable peripheral device such as a smart phone.

According to the above-described video call system according to an embodiment of the present invention, when a video call participant who executes a video call service in front of a digital TV wants to show an object located in another space to another participant who executes the video call service, the video call participant may continuously execute the video call service while moving to the other space and imaging the object located in the other space using a portable peripheral device such as a smart phone.

According to the above-described video call system according to an embodiment of the present invention, when a person located in another space wants to participate in a video call service in a state that the video call service is executed through a digital TV, the person may participate in the video call service using a peripheral device located near the digital TV without movement to the front of the digital TV.

According to the above-described screen sharing system according to an embodiment of the present invention, a screen data providing subject for a screen sharing service may be switched to various devices, and thus the screen sharing service may be more widely used. In particular, the screen sharing service may be more widely used using data installed in various devices through the screen sharing service.

### DESCRIPTION OF DRAWINGS

FIG. 1 is a diagram illustrating an interaction service providing system according to various embodiments of the present invention,

FIG. 2 is a block diagram illustrating a transmission-side user terminal device according to various embodiments of the present invention,

FIG. 3 is a detailed block diagram illustrating the transmission-side user terminal device of FIG. 2,

FIGS. 4(a), 4(b), 4(c), 5(a), 5(b) and 5(c) are diagrams explaining a video call service providing method according to an embodiment of the present invention,

FIGS. 6(a) and 6(b) are diagrams explaining a screen sharing service providing method according to an embodiment of the present invention,

FIG. 7 is a timing diagram explaining a video call service providing method according to an embodiment of the present invention,

FIG. 8 is a timing diagram explaining a screen sharing service providing method according to an embodiment of the present invention, and

FIGS. 9 and 10 are diagrams illustrating an interaction service providing system according to various embodiments of the present invention.

### MODE FOR INVENTION

Hereinafter, the present invention will be described in detail with reference to the accompanying drawings.

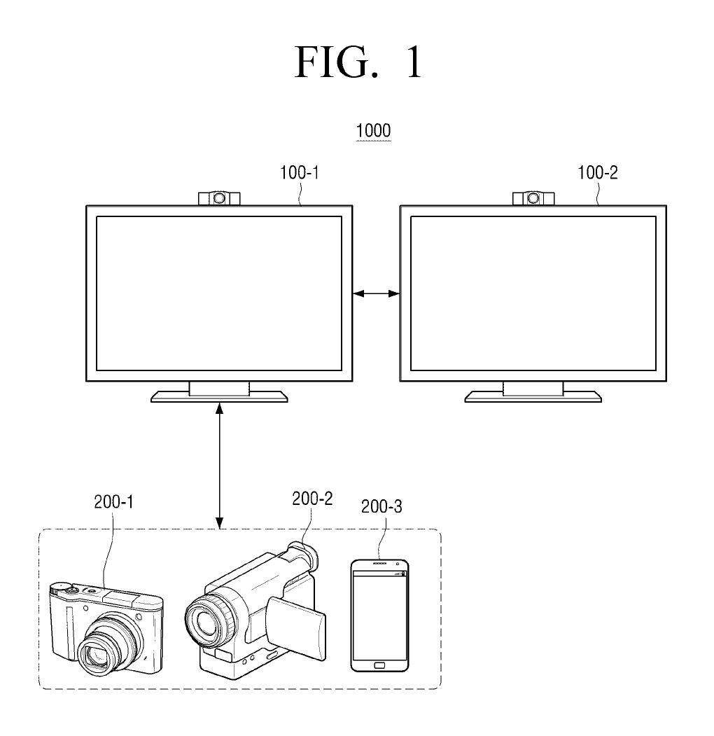

FIG. 1 is a diagram illustrating an interaction service providing system according to various embodiments of the present invention. Referring to FIG. 1, an interaction service providing system 1000 includes user terminal devices 100-1 and 100-2 and peripheral devices 200-1, 200-2, and 200-3. Here, the interaction service may include a video call service and a screen sharing service.

The video call service refers to service that participants interact with each other in real time while facing to face with each other. In the disclosure, the video call service includes a video call service that two participants interact with each other in real time while facing to face with each other and a video conference service that three or more participants interact with each other in real time while facing to face with each other.

The screen sharing service refers to service that participants interact with each other in real time while viewing a screen common to each other.

In response to the interaction service being the video call service, the user terminal devices 100-1 and 100-2 may be implemented with various devices having a camera and/or a microphone such as a smart phone, a tablet computer, a laptop computer, a personal digital assistant (PDA), a portable multimedia player (PMP), a navigation system, and a digital TV. The peripheral devices 200-1, 200-2, and 200-3 may be implemented with various devices having a camera and/or a microphone such as a smart phone, a tablet computer, a laptop computer, a PDA, a PMP, a navigation system, a digital TV, a camcorder, and a digital camera.

In response to the interaction service being the screen sharing service, the user terminal devices 100-1 and 100-2 and the peripheral devices 200-1, 200-2, and 200-3 may be implemented with the above-described various devices. However, the user terminal devices 100-1 and 100-2 and the peripheral devices 200-1, 200-2, and 200-3 may not necessarily include the camera and/or the microphone.

The communication between the user terminal device 100-1 and the user terminal device 100-2 and the communication between the user terminal device 100-1 and the peripheral devices 200-1, 200-2, and 200-3 may be connected in a wired or wireless connection form through a local area network (LAN) and an Internet network, in a connection form through a universal serial bus (USB) port, in a connection form through a mobile communication network such as 3G or 4G, or in a connection form through a short-range wireless communication method such as Bluetooth, near field communication (NFC), radio frequency identification (RFID), or Zigbee according to the implementation types of the devices.

FIG. 1 is a diagram illustrating an example that the user terminal devices 100-1 and 100-2 are implemented with a digital TV, and the peripheral devices 200-1, 200-2, and 200-3 are implemented with a digital camera, a camcorder, and a smart phone according to an aspect of the present invention.

Hereinafter, for clarity, it will be described that the user terminal device 100-1 refers to a transmission-side user terminal device 100-1 which transmits data transmitted from the peripheral devices 200-1 and 200-2, and 200-3 to the user terminal device 100-2, and the user terminal device 100-2 refers to a reception-side user terminal device 100-2 which receives the data transmitted from the peripheral devices 200-1, 200-2, and 200-3 from the user terminal device 100-1.

It has been illustrated and described in FIG. 1 that the reception-side user terminal device 100-2 is one, but this is not limited thereto. Accordingly, in response to a plurality of interaction service participants being presented, a plurality of reception-side user terminal devices 100-2 may be provided.

### <Video Call System>

The transmission-side user terminal device 100-1 and the reception-side user terminal device 100-2 may execute a video call service. Here, the video call service may be executed through mutual exchange of images imaged in the transmission-side user terminal device 100-1 and the reception-side user terminal device 100-2 and/or voices received in the transmission-side user terminal device 100-1 and the reception-side user terminal device 100-2.

The transmission-side user terminal device 100-1 may search for peripheral devices 200-1, 200-2, and 200-3 to be used as a data input source with respect to the video call service during the execution of the video call service.

Here, the ‘peripheral devices 200-1, 200-2, and 200-3 to be used as a data input source’ refer to peripheral devices 200-1, 200-2, and 200-3 which are to provide video call data transmitted from the transmission-side user terminal device 100-1 to the reception-side user terminal device 100-2 in the video call service.

The transmission-side user terminal device 100-1 may display the searched peripheral devices 200-1, 200-2, and 200-3.

In response to at least one peripheral device being selected among the displayed peripheral devices 200-1, 200-2, and 200-3, the transmission-side user terminal device 100-1 may display a data type providable in the selected at least one peripheral device.

Here, the ‘data type providable in the peripheral device’ may include at least one among a multimedia data type pre-stored in the peripheral device, a data type imaged in real time in the peripheral device, and a data type received in real time in the peripheral device.

In response to at least one data type among the displayed data types being selected, the transmission-side user terminal device 100-1 may receive video call data corresponding to the selected data type from the selected at least one peripheral device.

For example, in response to the ‘multimedia data type pre-stored in the peripheral device’ being selected, the transmission-side user terminal device 100-1 may display moving image data, still image data, voice data, and the like pre-stored in the peripheral device. In response to the moving image data pre-stored in the peripheral device being selected, the selected peripheral device may transmit the selected moving image data to the transmission-side user terminal device 100-1.

In response to the ‘data type imaged in real time in the peripheral device’ being selected, the peripheral device may turn on a camera function and may transmit the data imaged in real time through the camera to the reception-side user terminal device 100-1.

In response to the ‘data type received in real time in the peripheral device’ being selected, the peripheral device may turn on a microphone function and may transmit the data received in real time through the microphone to the transmission-side user terminal device 100-1.

That is, the video call data received from the peripheral devices 200-1, 200-2, and 200-3 may be changed according to the selected data type.

In response to the video call data being received from the selected at least one peripheral device, the transmission-side user terminal device 100-1 may switch the video call data to be transmitted to the reception-side user terminal apparatus 100-2 not to an image and/or an voice which are imaged and/or received in the transmission-side user terminal device 100-1 but to the video call data received from the peripheral devices 200-1, 200-2, and 200-3.

Accordingly, the transmission-side user terminal device 100-1 may transmit the video call data received from the peripheral devices 200-1, 200-2, and 200-3 to the reception-side user terminal device 100-2.

Therefore, the transmission-side user terminal device 100-1 and the reception-side user terminal device 100-2 may execute the video call service using the video call data received from the selected at least one peripheral device.

According to the above-described video call system according to an embodiment of the present invention, a video call participant who executes a video call service in front of a digital TV may continuously execute the video call service while moving to another space using a portable peripheral device such as a smart phone.

According to the above-described video call system according to an embodiment of the present invention, when a video call participant who executes a video call service in front of a digital TV wants to show an object located in another space to another participant who executes the video call service, the video call participant may continuously execute the video call service while moving to the other space and imaging the object located in the other space using a portable peripheral device such as a smart phone.

According to the above-described video call system according to an embodiment of the present invention, when a person located in another space wants to participate in a video call service in a state that the video call service is executed through a digital TV, the person may participate in the video call service using a peripheral device located near the digital TV without movement to the front of the digital TV.

### <Screen Sharing System>

*The transmission-side user terminal device 100-1 and the reception-side user terminal device 100-2 may execute a screen sharing service. Here, the screen sharing service refers to service in which the transmission-side user terminal device 100-1 and the reception-side user terminal device 100-2 interact with each other in real time through screen sharing while viewing the same screen.

The transmission-side user terminal device 100-1 may search for the peripheral devices 200-1, 200-2, and 200-3 to be used as a data input source with respect to the screen sharing service during the execution of the screen sharing service.

Here, the ‘peripheral devices 200-1, 200-2, and 200-3 to be used as a data input source’ refer to the peripheral devices 200-1, 200-2, and 200-3 which are to provide screen data transmitted from the transmission-side user terminal device 100-1 to the reception-side user terminal device 100-2 in the screen sharing service.

The transmission-side user terminal device 100-1 may display the searched peripheral devices 200-1, 200-2, and 200-3.

In response to a peripheral device being selected among the displayed peripheral devices 200-1, 200-2, and 200-3, the transmission-side user terminal device 100-1 may receive the screen data from the selected peripheral device. Here, the ‘screen data’ may refer to data according to capture of a screen currently displayed in the selected peripheral device.

In response to the screen data being received from the selected peripheral device, the transmission-side user terminal device 100-1 may switch screen data to be transmitted to the reception-side user terminal device 100-2 not to screen data corresponding to a screen displayed in the transmission-side user terminal device 100-1 but to screen data received from the peripheral devices 200-1, 200-2, and 200-3.

Accordingly, the transmission-side user terminal device 100-1 may transmit the screen data received from the peripheral devices 200-1, 200-2, and 200-3 to the reception-side user terminal device 100-2.

Therefore, the transmission-side user terminal device 100-1 and the reception-side user terminal device 100-2 may execute the screen sharing service using the screen data received from the selected peripheral device.

The transmission-side user terminal device 100-1 may receive a user input for the transmission-side user terminal device 100-1. Here, the user input may be a user input which operates the screen displayed in the transmission-side user terminal device 100-1 using a touch input, a mouse, a keyboard, a remote controller, and the like.

The transmission-side user terminal device 100-1 may transmit location information corresponding to the received user input to the selected peripheral device.

In response to the position information being received, the selected peripheral device may perform an operation corresponding to the location information (for example, application execution) and display a screen corresponding to the performing operation. The selected peripheral device may transmit screen data corresponding to the currently displayed screen to the transmission-side user terminal device 100-1.

The transmission-side user terminal apparatus 100-1 may transmit the screen data received from the peripheral devices 200-1, 200-2, and 200-3 to the reception-side user terminal device 100-2, and the transmission-side user terminal device 100-1 and the reception-side user terminal device 100-2 may execute the screen sharing service using the screen data received from the selected peripheral device.

*According to the above-described screen sharing system according to an embodiment of the present invention, a screen data providing subject with respect to a screen sharing service may be switched to various devices, and thus the screen sharing service may be more widely used. In particular, the screen sharing system may more widely use the screen sharing service using data installed in various devices through the screen sharing service.

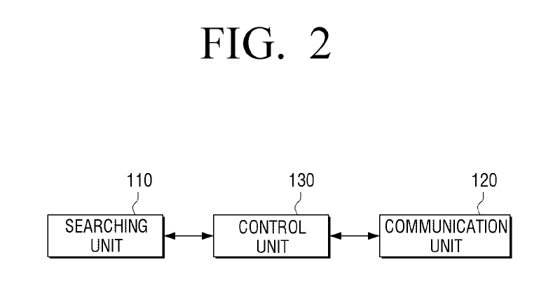

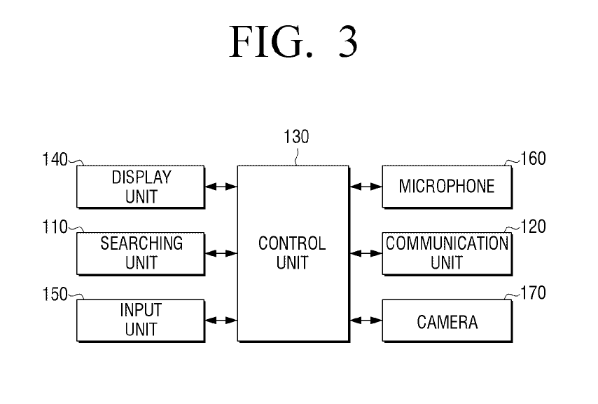

FIG. 2 is a block diagram illustrating a transmission-side user terminal device according to various embodiments of the present invention. FIG. 3 is a detailed block diagram illustrating the transmission-side user terminal device of FIG. 2. Referring to FIGS. 2 and 3, the user terminal device 100-1 includes all or a portion of the searching unit 110, a communication unit 120, a control unit 130, a display unit 140, an input unit 150, a microphone 160, and a camera 170. Hereinafter, the transmission-side user terminal device 100-1 used in the video call system or the screen sharing system according to an embodiment of the present invention will be described in detail with reference to FIGS. 2 and 3.

### <Video Call System>

The searching unit 110 searches for peripheral devices to be used as a data input source with respect to the video call service. The searching unit 110 may search for the peripheral devices to be used as the data input source with respect to the video call service using a universal plug and play (UPnP) function or a digital living network alliance (DLNA) function.

For example, in response to the UPnP function being used in the searching unit 110, the searching unit 110 may generate a ‘search request signal’ and transmit the generated ‘search request signal’ to the peripheral devices 200-1, 200-2, and 200-3 through the communication unit 120. The peripheral devices 200-1, 200-2, and 200-3 may generate a ‘search request response signal’ with respect to the search request signal and transmit the generated ‘search request response signal’ to the transmission-side user terminal device 100-1.

Here, the ‘search request response signal’ may include ‘peripheral device information’ such as model number information, model name information, serial number information, manufacturer name information, providable data type information, and device type information of the peripheral devices 200-1, 200-2, and 200-3.

The device type information refers to information which describes a device type indicating whether the device is a camera, camcorder, or a smart phone and the like.

The data type information providable in the peripheral device refers to information which describes whether multimedia data is stored in the peripheral device, whether a camera is provided in the peripheral device, whether a microphone is provided in the peripheral device, and the like.

Accordingly, the searching unit 110 may search for the peripheral devices to be used as a data input source with respect to the video call service.

The communication unit 120 may allow the transmission-side user terminal device 100-1 to communicate with the peripheral devices 200-1, 200-2, and 200-3 and the reception-side user terminal device 100-2.

In particular, the communication unit 120 may receive the ‘video call data’ from the peripheral devices 200-1, 200-2, and 200-3. The communication unit 120 may transmit the received ‘video call data’ to the reception-side user terminal device 100-2.

Here, the communication unit 120 may perform communication using a communication network formed between the transmission-side user terminal device 100-1 and the reception-side user terminal device 100-2 or between the transmission-side user terminal device 100-1 and the peripheral devices 200-1, 200-2, and 200-3.

The display unit 140 performs a screen display function. In particular, the display unit 140 may display a video call service screen executed between the transmission-side user terminal device 100-1 and the reception-side user terminal device 100-2.

Here, the ‘video call service screen’ may display an image imaged in the transmission-side user terminal device 100-1 and/or an image imaged in the reception-side user terminal device 100-2 before the data input source is switched to the peripheral device.

The video call service screen may include a ‘data input source switch UI window’. The ‘data input source switch UI window’ refers to a UI window for switching the data input source with respect to the video call service from the camera 170 and/or the microphone 160 provided in the transmission-side user terminal device 100-1 to the peripheral devices 200-1, 200-2, and 200-3.

In response to the ‘data input source switch UI window’ being selected through the input unit 150, the display unit 140 may display the peripheral devices searched through the searching unit 110. Here, the displayed peripheral devices may be displayed together with at least one among model number information, model name information, serial number information, manufacturer name information, and device type information.

In response to at least one peripheral device among the displayed peripheral devices being selected through the input unit 150, the display 140 may display data types providable in the selected peripheral device.

In response to at least one data type among the displayed data types being selected, the data input source may be switched to the peripheral device. Accordingly, the ‘video call service screen’ may display a screen corresponding to the video call data received from the peripheral devices 200-1, 200-2, and 200-3 and/or an image imaged in the reception-side user terminal device 100-2.

The display unit 140 may be implemented with at least one among a liquid crystal display, a thin film transistor-liquid crystal display, an organic light-emitting diode, a flexible display, a 3D display, and a transparent display.

The input unit 150 receives a user input with respect to the transmission-side user terminal device 100-1. Here, the input unit 150 may be implemented with a touch sensor. The touch sensor may be implemented with a capacitive type or pressure type. Accordingly, in response to a touch input of the user being received, the input unit 150 may transfer an electrical signal corresponding to a touched point to the control unit 130, and the control unit 130 may recognize the touch point using a coordinate to which the electrical signal is transferred.

The input unit 150 may be implemented with a proximity sensor. The proximity sensor may be a sensor for detecting a motion which approaches a surface of the display unit 140 without direct contact with the surface of the display unit 140. The proximity sensor may be implemented with various types of sensors such as a high frequency oscillation type sensor which detects a current induced through a magnetic field characteristic changed in approach of an object by forming a high frequency magnetic field, a magnetic type sensor using a magnet, and a capacitive type sensor which detects electrostatic capacitance changed by approach of an object. Therefore, in response to the user input according to an approaching motion being received, the input unit 150 may transfer the electrical signal corresponding to the user input to the control unit 130, and the control unit 130 may recognize the user input according to a proximity motion using the transferred electrical signal.

The input unit 150 may be implemented by combining an input device such as a mouse, a keyboard, or a remote controller with a display device such as the display unit 140. The control unit 130 may perform a function corresponding to the user input using the user input received through the input device.

Here, the input unit 150 may be configured to include at least one among the above-described components which receive the user input.

The microphone 160 receives a voice uttered by the user. In particular, the microphone 160 may receive a voice of a participant to be used in the video call service.

The camera 170 images an image. In particular, the camera 170 may image an image of the participant to be used in the video call service.

The control unit 130 controls an overall operation of the transmission-side user terminal device 100-1. Specifically, the control unit 130 may control all or a portion of the searching unit 110, the communication unit 120, the display unit 140, the input unit 150, the microphone 160, and the camera 170.

In particular, the control unit 130 may monitor a network state using bandwidth information, delay information, packet loss information, and the like of a communication network formed between the transmission-side user terminal device 100-1 and the selected at least one peripheral device.

In response to the communication network formed between the transmission-side user terminal device 100-1 and the selected at least one peripheral device being a wired communication network, the control unit 130 may determine the communication method between the transmission-side user terminal device 100-1 and the selected at least one peripheral device to a real time transmission method. In response to the communication network formed between the transmission-side user terminal device 100-1 and the selected at least one peripheral device being a wireless communication network and a size of video call data to be received being smaller than a preset size, the control unit 130 may determine the communication method between the transmission-side user terminal apparatus 100-1 and the selected at least one peripheral device to the real time transmission method.

Here, the real time transmission method refers to a transmission method in which the peripheral device and the transmission-side user terminal device 100-1 transmit and receive the video call data in a RAW data form.

In response to the data transmission method being determined as the real time transmission method, the control unit 130 may control the communication unit 120 to receive the video call data through the real time transmission method.

In response to the video call data being received through the real time transmission method, the control unit 130 may transmit the received video call data to the reception-side user terminal device 100-2 by switching the received video call data to correspond to the session information with respect to the video call service executed between the transmission-side user terminal device 100-1 and the reception-side user terminal device 100-2.

For example, in response to the session information with respect to the video call service executed between the transmission-side user terminal device 100-1 and the reception-side user terminal device 100-2 being set to ‘resolution:1920*1080’, ‘frame rate: 60 Hz’, and the like and the video call data received in the real time transmission method being ‘resolution: 640*480’ and ‘frame rate: 30 Hz’, the control unit 130 may transmit the received video call data to the reception-side user terminal device 100-2 by converting the resolution of the received video call data to 1920*1080 and converting the frame rate to 60 Hz.

However, this is merely for clarity on description, and the converted session information is not limited thereto. Accordingly, the control unit 130 may convert various pieces of information such as codec, audio, or ports with respect to the received video call data to correspond to the session information with respect to the video call service executed between the transmission-side user terminal device 100-1 and the reception-side user terminal device 100-2 and transmit the converted information to the reception-side user terminal device 100-2.

In response to the communication network formed between the transmission-side user terminal device 100-1 and the selected at least one user terminal device being a wireless communication network and a size of the video call data to be received being larger than the preset size, the control unit 130 may determine the communication method between the transmission-side user terminal device 100-1 and the selected at least one peripheral device to the streaming method.

In response to the communication method being determined as the streaming method, the control unit 130 may control the communication unit 120 to perform negotiation for streaming on the peripheral device. Here, the negotiation may refer to the step of adjusting the existing session information set between the transmission-side user terminal device 100-1 and the peripheral devices 200-1, 200-2, and 200-3 by reflecting the monitored network state and the session information with respect to the video call service executed between the transmission-side user terminal device 100-1 and the reception-side user terminal device 100-2.

For example, in response to the transmission-side user terminal device 100-1 and the peripheral devices 200-1, 200-2, and 200-3 being connected at 1 Mbps in the existing session information set between the transmission-side user terminal device 100-1 and the peripheral devices 200-1, 200-2, and 200-3, but the connection being possible only at 500 kbps in the current monitored network state, the control unit 130 may adjust the existing session information to 500 kbps according to the above-described negotiation.

In response to the session information with respect to the video call service executed between the transmission-side user terminal device 100-1 and the reception-side user terminal device 100-2 being set to ‘resolution: 1920*1080’, ‘frame rate: 60 Hz’, and the like, the control unit 130 may adjust the existing session information so that a peripheral device 200 transmits the video call data to the transmission-side user terminal device 100-1 by adjusting the session information to ‘resolution: 1920*1080’ and ‘frame rate: 60 Hz’ according to the negotiation.

However, this is merely for clarity on description, and the converted session information is not limited thereto. Accordingly, the control unit 130 may adjust various pieces of information such as codec, audio, ports with respect to the received video call data.

That is, the streaming method refers to a method in which the peripheral device and the transmission-side user terminal device 100-1 transmit and receive the video call data modified by reflecting the above-described negotiation result unlike the real time transmission method in which the video call data is transmitted and received in a RAW data form having large capacity.

In response to the existing session information set between the transmission-side user terminal device 100-1 and the peripheral devices 200-1, 200-2, and 200-3 being adjusted by reflecting the session information with respect to the video call service executed between the transmission-side user terminal device 100-1 and the reception-side user terminal device 100-2 as the negotiation result, the control unit 130 may control the communication unit 120 to transmit the received video call data to the reception-side user terminal device 100-2 without separate graphic processing on the received video call data.

In response to the existing session information set between the transmission-side user terminal device 100-1 and the peripheral devices 200-1, 200-2, and 200-3 being not adjusted by reflecting the session information with respect to the video call service executed between the transmission-side user terminal device 100-1 and the reception-side user terminal device 100-2 as the negotiation result, the control unit 130 may control the communication unit 120 to transmit the received video call data to the reception-side user terminal device 100-2 by performing separate graphic processing (for example, resolution adjustment, frame rate adjustment, codec change, and the like) on the received video call data.

In response to the video call data being received from the selected at least one user terminal device, the control unit 130 may switch the video call data to be transmitted to the reception-side user terminal device 100-2 not to the image and/or the voice which are imaged and/or received in the transmission-side user terminal device 100-1 but to the video call data received from the peripheral devices 200-1, 200-2, and 200-3. Accordingly, the control unit 130 may control the communication unit 120 to transmit the video call data received from the peripheral devices 200-1, 200-2, and 200-3 to the reception-side user terminal device 100-2.

In response to the video call data being switched, the control unit 130 may control the display unit 140 to display a ‘video call service screen’ including a screen corresponding to the video call data received from the peripheral devices 200-1, 200-2, and 200-3.

Accordingly, the transmission-side user terminal device 100-1 and the reception-side user terminal device 100-2 may execute the video call service with the video call data received from the peripheral device.

### <Screen Sharing System>

The transmission-side user terminal device 100-1 used in the screen sharing system may be operated similar to the transmission-side user terminal device 100-1 used in the above-described video call system other than a difference according to the characteristic of the screen sharing service. In particular, operations of the searching unit 110, the communication unit 120, the display unit 140, and the input unit 150 may be the same as those of the transmission-side user terminal device 100-1 used in the above-described video call system other than the difference according to the characteristic of the screen sharing service. Accordingly, the transmission-side user terminal device 100-1 in the screen sharing system will be described in detail by focusing on the difference with reference to FIGS. 2 and 3. The transmission-side user terminal device 100-1 may not include the camera 170 and the microphone 160 according to the characteristic of the screen sharing service.

In response to at least one peripheral device being selected among the peripheral devices 200-1, 200-2, and 200-3 displayed in the display unit 140, the control unit 130 may request screen data to the selected peripheral device.

In response to the screen data corresponding to the screen currently displayed in the selected peripheral device being received according to the request, the control unit 130 may control the display unit 140 to switch the existing screen data to the screen data received from the peripheral device and to display the switched screen data.

The control unit 130 may control the communication unit 120 to transmit the screen data received from the peripheral device to the reception-side user terminal device 100-2.

Accordingly, the transmission-side user terminal device 100-1 and the reception-side user terminal device 100-2 may execute the screen sharing service with the screen data received from the peripheral device.

In response to a user input which operates the transmission-side user terminal device 100-1 being received through the input unit 150, the control unit 130 may control the communication unit 120 to transmit position information corresponding to the received user input to the peripheral device 200. Here, the user input may be a user input which operates the displayed screen using a touch input, a mouse, a keyboard, a remote controller, and the like.

In this case, the peripheral device 200 may calculate position information in the peripheral device which matches with the received position information. The peripheral device 200 may perform a function in the calculated position information. The peripheral device 200 may switch the displayed screen to a specific function executing screen.

In this case, the control unit 130 may repeat the above-described operation.

Accordingly, the transmission-side user terminal device 100-1 and the reception-side user terminal device 100-2 may execute the screen sharing service with the switched screen data displayed in the peripheral device.

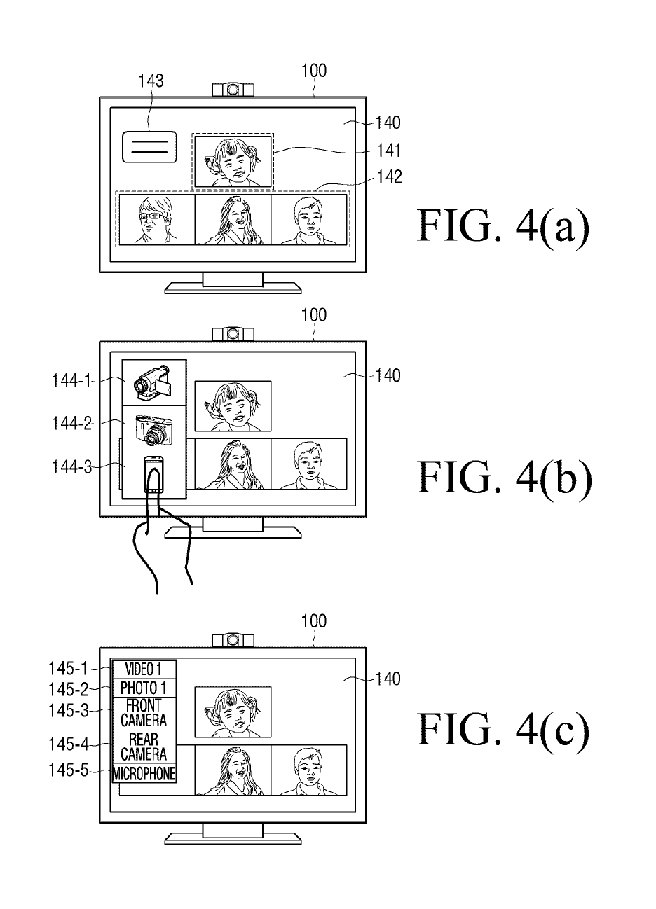

FIGS. 4(a), 4(b) and 4(c) are diagrams explaining a video call service providing method according to an embodiment of the present invention. Referring to FIG. 4(a), the display unit 140 may display a video call service screen executed between the transmission-side user terminal device 100-1 and the reception-side user terminal device 100-2. Here, FIG. 4(a) illustrates the video call service screen before the data input source is switched to the peripheral device, and the ‘video call service screen’ may display an image 141 imaged in the transmission-side user terminal device 100-1 and an image 142 imaged in the reception-side user terminal device 100-2. The video call service screen may include a data input source switch UI window 143.

In response to the data input source switch UI window 143 being selected, the display unit 140 may display peripheral devices 144-1, 144-2, and 144-3 searched through the searching unit 110 as illustrated in FIG. 4(b). Here, the displayed peripheral devices may be displayed together with device type information.

In response to the peripheral device 144-3 being selected among the displayed peripheral devices 144-1, 144-2, and 144-3, the display unit 140 may display data types 145-1, 145-2, 145-3, 145-4, and 145-5 providable in the selected peripheral device 144-3 as illustrated in FIG. 4(c). Here, the displayed data types 145-1, 145-2, 145-3, 145-4, and 145-5 may be changed according to the selected peripheral device. For example, in response to a smart phone 144-3 being selected, a moving image 145-1, a photo 145-2, a front camera 145-3, a rear camera 145-4, and a microphone 145-5 may be displayed as the data type providable from the smart phone as illustrated in FIG. 4(c).

Here, in response to the moving image 145-1 being selected, the transmission-side user terminal device 100-1 may display moving image data pre-stored in the smart phone 144-3. In this case, in response to the displayed specific moving image data being selected, the transmission-side user terminal device 100-1 may receive the selected moving image data in the smart phone 144-3.

In response to the photo 145-2 being selected, the transmission-side user terminal device 100-1 may display photo data pre-stored in the smart phone 144-3. In this case, in response to the displayed specific photo data being selected, the transmission-side user terminal device 100-1 may receive the selected photo data from the smart phone 144-3.

In response to the front camera 145-3 being selected, the transmission-side user terminal device 100-1 may receive data imaged in real time in a front camera of the smart phone 144-3 from the smart phone 144-3.

In response to the rear camera 145-4 being selected, the transmission-side user terminal device 100-1 may receive data imaged in real time in a rear camera of the smart phone 144-3 from the smart phone 144-3.

In response to the microphone 145-5 being selected, the transmission-side user terminal device 100-1 may receive voice data received in real time in a microphone of the smart phone 144-3 from the smart phone 144-3.

At least one or more data types may be selected. Accordingly, in response to the rear camera 145-4 and the microphone 145-5 being simultaneously selected, the transmission-side user terminal device 100-1 may receive voice data received in real time in the microphone of the smart phone 144-3 as well as data imaged in real time in the rear camera of the smart phone 144-3 from the smart phone 144-3.

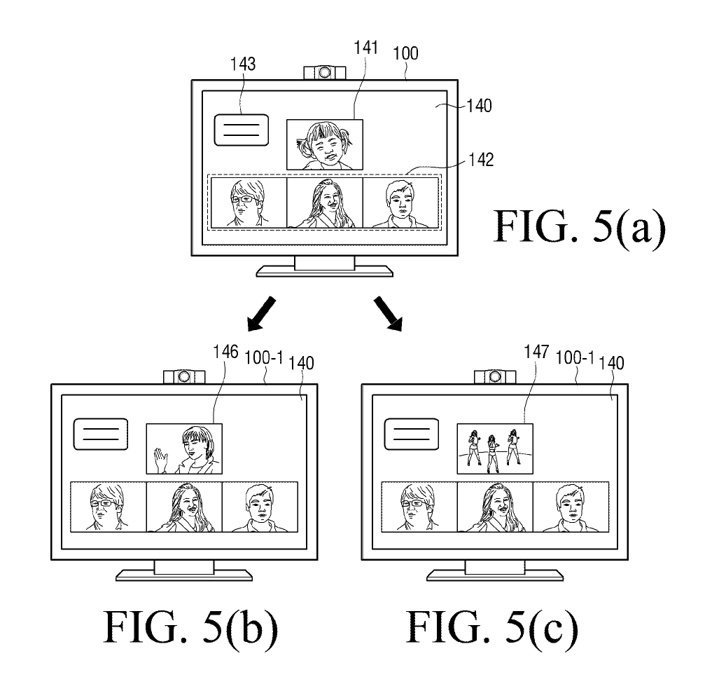

FIGS. 5(a), 5(b) and 5(c) are diagrams illustrating a video call service providing method according to an embodiment of the present invention. Referring to FIG. 5(a), the display unit 140 may display a video call service screen executed between the transmission-side user terminal device 100-1 and the reception-side user terminal device 100-2. Here, FIG. 5(a) illustrates the video call service screen before the data input source is switched to the peripheral device. The ‘video call service screen’ may display an image 141 imaged in the transmission-side user terminal device 100-1 and an image 142 imaged in the reception-side user terminal device 100-2. The video call service screen may include a data input source switch UI window 143.

Like the operation as described in FIGS. 4(a)-4(c), in response to at least one data type being selected among displayed data types, the data input source may be switched to a peripheral device.

In response to the cameras 145-3 and 145-4 or the cameras 145-3 and 145-4 and the microphone 145-5 being selected among the displayed data types, the ‘video call service screen’ may display a screen 146 corresponding to video call data received from the selected peripheral device and an image imaged in the reception-side user terminal device 100-2 as illustrated in FIG. 5(b).

In response to the moving image 145-1 or the photo 145-2 being selected among the displayed data types, the ‘video call service screen’ may display a screen 147 corresponding to video call data received from the selected peripheral device and an image imaged in the reception-side user terminal device 100-2 as illustrated in FIG. 5(c).

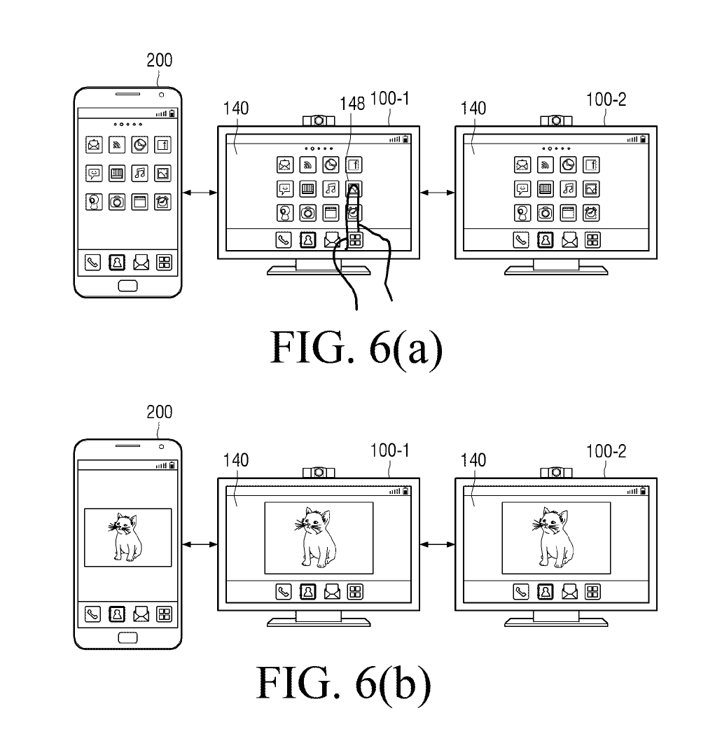

FIGS. 6(a) and 6(b) are diagrams illustrating a screen sharing service providing method according to an embodiment of the present invention. In response to the screen sharing service according to an embodiment of the present invention being executed, the peripheral device 200, the transmission-side user terminal device 100-1, and the reception-side user terminal device 100-2 may display the same screen as illustrated in FIG. 6(a). As described above, the screen sharing service in which the transmission-side user terminal device 100-1 and the reception-side user terminal device 100-2 share the screen of the peripheral device 200 may be executed through the following operation.

That is, the transmission-side user terminal device 100-1 may search for the peripheral devices 200 to be used as a data input source with respect to the screen sharing service during the execution of the screen sharing service. The transmission-side user terminal device 100-1 may display the searched peripheral devices 200. In response to a peripheral device being selected from the displayed peripheral devices 200, the transmission-side user terminal device 100-1 may receive screen data from the selected peripheral device 200. In response to the screen data being received from the selected peripheral device, the transmission-side user terminal device 100-1 may switch screen data to be transmitted to the reception-side user terminal device 100-2 not to screen data corresponding to a screen displayed in the transmission-side user terminal device 100-1 but to screen data received from the peripheral device 200. Accordingly, as illustrated in FIG. 6(a), the screen sharing service in which the transmission-side user terminal device 100-1 and the reception-side user terminal device 100-2 share the screen of the peripheral device 200 which displays a plurality of executable applications may be executed.

In response to a user input for selecting a ‘photo application’ being received in a state that the display unit 140 displays the sharing screen, the peripheral device 200 may execute the ‘photo application’ and display a ‘photo application execution screen’. Even in this case, the screen sharing service in which the transmission-side user terminal device 100-1 and the reception-side user terminal device 100-2 share the screen of the peripheral device 200 which displays the ‘photo application execution screen’ may be executed. The above-described operation may be executed through the following operation as described in FIG. 6(b). For clarity, an example that the ‘photo application’ is selected by a touch input as illustrated in FIG. 6(a) will be described.

The transmission-side user terminal device 100-1 may transmit position information corresponding to the received touch input to the selected peripheral device 200.

The peripheral device may calculate position information in the peripheral device 200 which matches with the received position information.

Accordingly, the peripheral device may recognize that the ‘photo application’ is selected in the transmission-side user terminal device 100-1 and display a ‘photo application execution screen’ by executing the ‘photo application’. The peripheral device 200 may transmit screen data corresponding to the ‘photo application execution screen’ to the transmission-side user terminal device 100-1.

The transmission-side user terminal device 100-1 may transmit the screen data received from the peripheral device 200 to the reception-side user terminal device 100-2, and thus the screen sharing service in which the transmission-side user terminal device 100-1 and the reception-side user terminal device 100-2 share the screen of the peripheral device 200 which displays the ‘photo application execution screen’ may be executed.

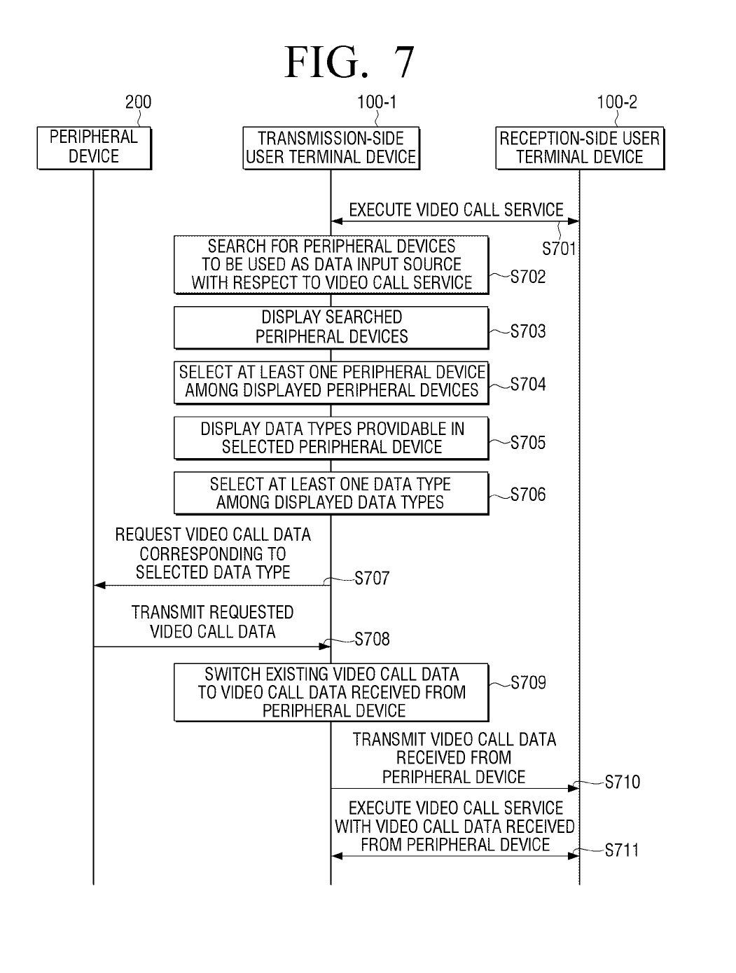

FIG. 7 is a timing diagram explaining a video call service providing method according to an embodiment of the present invention. Referring to FIG. 7, the transmission-side user terminal device 100-1 and the reception-side user terminal device 100-2 may execute a video call service (S701).

The transmission-side user terminal device 100-1 may search for peripheral devices 200 to be used as a data input source with respect to the video call service during the execution of the video call service (S702).

The transmission-side user terminal device 100-1 may display the searched peripheral devices 200 (S703). The transmission-side user terminal device 100-1 may receive selection for at least one peripheral device among the displayed peripheral devices 200 (S704). In response to the at least one peripheral device being selected, the transmission-side user terminal device 100-1 may display data types providable in the selected at least one peripheral device (S705).

The transmission-side user terminal device 100-1 may receive selection for at least one data type among the displayed data types (S706). In response to the at least one data type being selected, the transmission-side user terminal device 100-1 may request video call data corresponding to the selected data type to the selected at least one peripheral device 200 (S707).

The selected at least one peripheral device 200 may transmit the requested video call data to the transmission-side user terminal device 100-1 (S708).

The transmission-side user terminal device 100-1 may switch the existing video call data to the video call data received from the peripheral device 200 (S709).

The transmission-side user terminal device 100-1 may transmit the video call data received from the peripheral device 200 to the reception-side user terminal device 100-2 (S710).

Accordingly, the transmission-side user terminal device 100-1 and the reception-side user terminal device 100-2 may execute the video call service with the video call data received from the peripheral device.

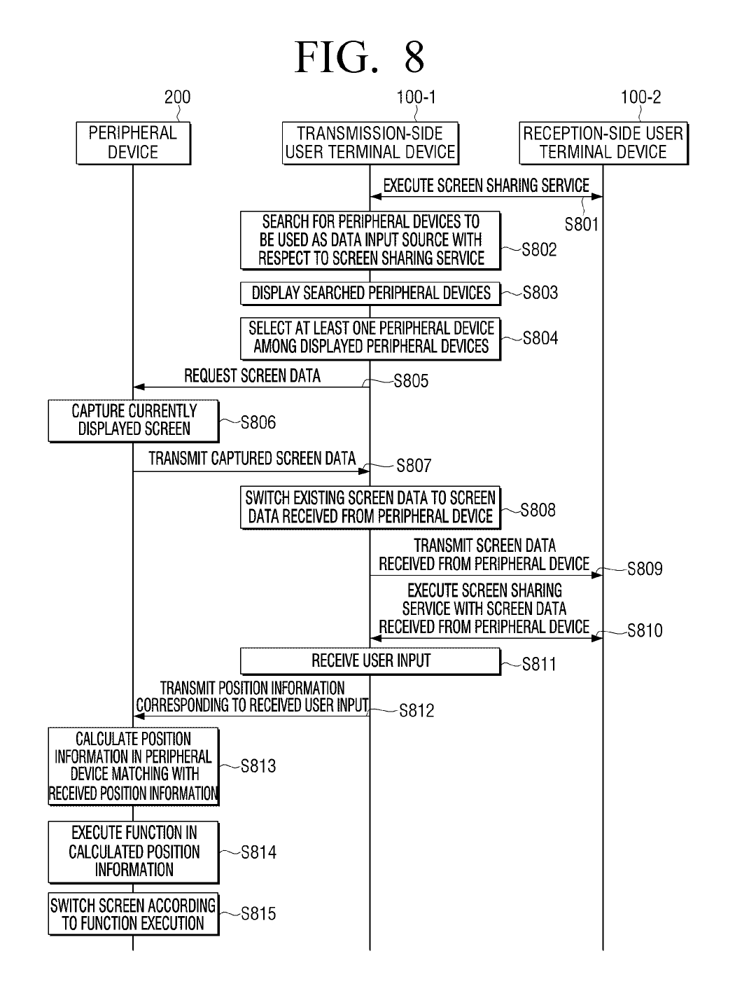

FIG. 8 is a timing diagram explaining a screen sharing service providing method according to an embodiment of the present invention. Referring to FIG. 8, the transmission-side user terminal device 100-1 and the reception-side user terminal device 100-2 may execute a screen sharing service (S801).

The transmission-side user terminal device 100-1 may search for peripheral devices 200 to be used as a data input source with respect to the screen sharing service during the execution of the screen sharing service (S802).

The transmission-side user terminal device 100-1 may display the searched peripheral devices 200 (S803). The transmission-side user terminal device 100-1 may receive selection for the at least one peripheral device among the displayed peripheral devices 200 (S804).

In response to the at least one peripheral device being selected, the transmission-side user terminal device 100-1 may request screen data to the selected at least one peripheral device (S805).

In response to the screen data request being received, the selected at least one peripheral device 200 may capture a currently displayed screen (S806). The selected at least one peripheral device 200 may transmit screen data corresponding to the captured screen to the transmission-side user terminal device (S807).

The transmission-side user terminal device 100-1 may switch the existing screen data to the screen data received from the peripheral device (S808). The transmission-side user terminal device 100-1 may transmit the screen data received from the peripheral device to the reception-side user terminal device 100-2 (S809).

Accordingly, the transmission-side user terminal device 100-1 and the reception-side user terminal device 100-2 may execute the screen sharing service with the screen data received from the peripheral device (S810).

*The transmission-side user terminal device 100-1 may receive a user input for operating the transmission-side user terminal device 100-1 (S811). In this case, the transmission-side user terminal device 100-1 may transmit position information corresponding to the received user input to the peripheral device 200 (S812).

In response to the position information being received, the peripheral device 200 may calculate position information in the peripheral device which matches with the received position information (S813). The peripheral device 200 may execute a function in the calculated position information (S814). The peripheral device 200 may switch the displayed screen according to the function execution (S815).

In this case, the transmission-side user terminal device 100-1 may repeat the above-described steps S807 to S810.

Accordingly, the transmission-side user terminal device 100-1 and the reception-side user terminal device 100-2 may execute the screen sharing service with the switched screen data displayed in the peripheral device.

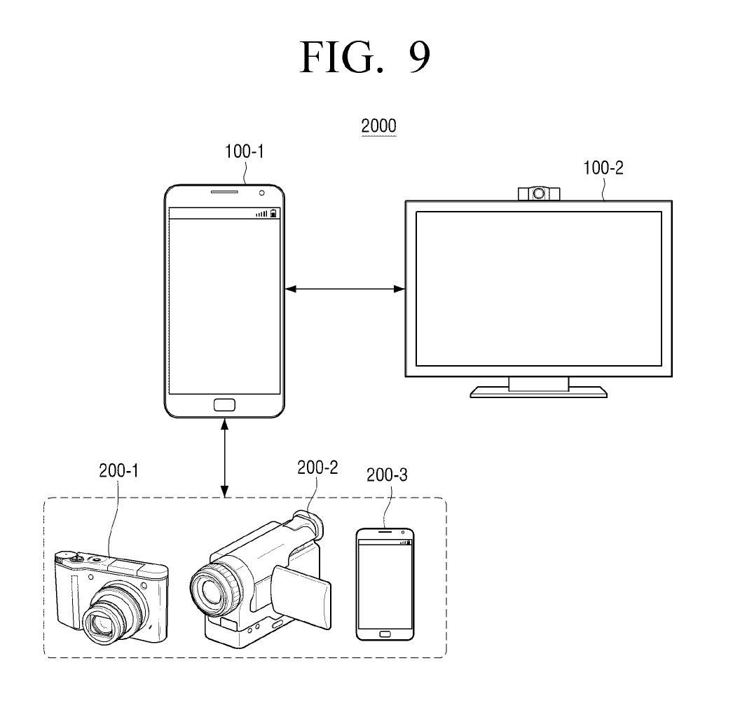

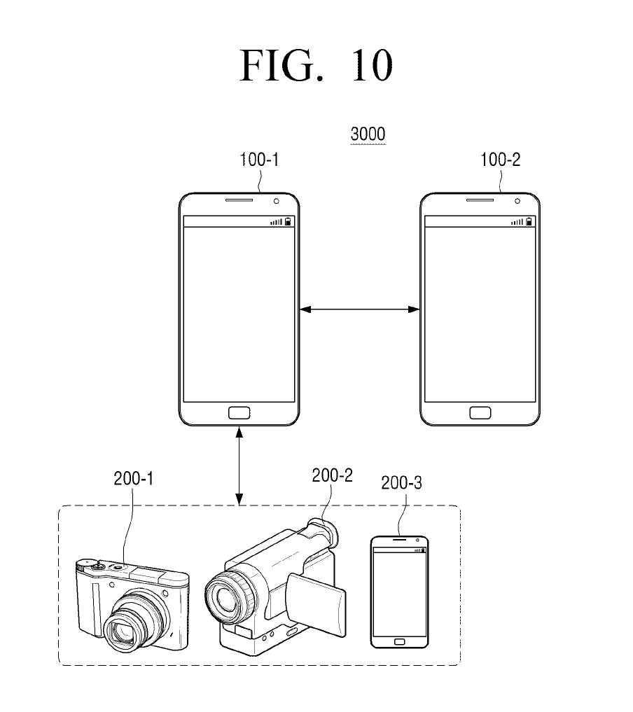

FIGS. 9 and 10 are diagrams illustrating interaction service providing systems according to various embodiments of the present invention. Referring to FIGS. 9 and 10, interaction providing systems 2000 and 3000 include user terminal devices 100-1 and 100-2 and peripheral devices 200-1, 200-2, and 200-3.

FIG. 9 is a diagram explaining an example that the transmission-side user terminal device 100-1 may be implemented with a smart phone, the reception-side user terminal device 100-2 may be implemented with a digital TV, and the peripheral devices 200-1, 200-2, and 200-3 may be implemented with a digital camera, a camcorder, and a smart phone, according to an aspect of the present invention.

FIG. 10 is a diagram explaining an example that the transmission-side user terminal device 100-1 and the reception-side user terminal device 100-2 may be implemented with a smart phone, respectively, and the peripheral devices 200-1, 200-2, and 200-3 may be implemented with a digital camera, a camcorder, and a smart phone, according to an aspect of the present invention.

Here, operations of the interaction service providing systems 2000 and 3000 according to FIGS. 9 and 10 may be the same as that of the interaction providing system 1000 in FIG. 1 other than an operational difference due to a difference of an implementation device. In particular, a communication method between the peripheral device 200 and the transmission-side user terminal device 100-1 may be different from a communication method between the transmission-side user terminal device 100-1 and the reception-side user terminal device 100-2 according to the difference of the implementation device. However, the communication method between the above-described devices is known technology, and thus detailed description thereof will be omitted.

The interaction providing methods according to the above-described various exemplary embodiments may be implemented with a program code and provided to servers or devices in a form stored in a non-transitory computer-readable medium.

The non-transitory computer-readable medium is not a medium configured to temporarily store data such as a register, a cache, or a memory but an apparatus-readable medium configured to permanently or semi-permanently store data. For example, the above-described applications and programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided.

The foregoing exemplary embodiments and advantages are merely exemplary and are not to be construed as limiting the present inventive concept. The description of the exemplary embodiments is intended to be illustrative, and not to limit the scope of the claims, and many alternatives, modifications, and variations will be apparent to those skilled in the art.

1. An interaction service providing method of a user terminal device, the method comprising the steps of: executing a video call service with a counterpart device; searching for peripheral devices to be used as a data input source with respect to the video call service; receiving video call data from at least one peripheral device among the searched peripheral devices; and transmitting the received video call data to the counterpart device.

2. The method according to claim 1, further comprising the steps of: displaying the searched peripheral devices; and receiving selection for a peripheral device to be used as the data input source with respect to the video call service among the displayed peripheral devices, wherein the step of receiving includes the step of receiving the video call data from the selected peripheral device.

3. The method according to claim 2, further comprising the steps of: in response to the peripheral device being selected, displaying data types providable in the selected peripheral device; and receiving selection for at least one data type among the displayed data types, wherein the step of receiving includes the step of receiving the video call data corresponding to the selected data type.

4. The method according to claim 3, wherein the data type includes at least one among a multimedia data type pre-stored in the peripheral device, an image data type imaged in real time in the peripheral device, and a voice data type received in real time in the peripheral device.

5. The method according to claim 1, further comprising the step of determining a communication method between the user terminal device and the selected peripheral device to a real time transmission method or a streaming method using wired/wireless information of a communication network formed between the user terminal device and the selected peripheral device and size information of video call data to be received from the selected peripheral device.

6. The method according to claim 5, further comprising the step of, in response to the transmission method being determined as the streaming method, performing negotiation on the peripheral device so that session information for the determined streaming method is corresponding to session information with respect to the video call service between the user terminal device and the counterpart device.

7. The method according to claim 2, further comprising the step of displaying a video call service screen including the video call data received from the selected peripheral device.

8. A user terminal device which executes a video call service with a counterpart device, the user terminal device including a searching unit which searches for peripheral devices to be used as a data input source with respect to the video call service; a communication unit which receives video call data from at least one peripheral device among the searched peripheral devices; and a control unit which controls the communication unit to transmit the received video call data to the counterpart device.

9. The user terminal device according to claim 8, further comprising: a display unit which displays the searched peripheral devices; and an input unit which receives selection for a peripheral device to be used as the data input source with respect to the video call service among the displayed peripheral devices, wherein the control unit controls the communication unit to receive the video call data from the selected peripheral device.

10. The user terminal device according to claim 9, wherein the display unit displays, in response to the peripheral device being selected, data types providable in the selected peripheral device, the input unit receives selection for at least one data type among the displayed data types, and the control unit controls the communication unit to receive the video call data corresponding to the selected data type.

11. The user terminal device according to claim 10, wherein the data type includes at least one among a multimedia data type pre-stored in the peripheral device, an image data type imaged in real time in the peripheral device, and a voice data type received in real time in the peripheral device.

12. The user terminal device according to claim 8, wherein the control unit determines a communication method between the user terminal device and the selected peripheral device to a real time transmission method or a streaming method using wired/wireless information of a communication network formed between the user terminal device and the selected peripheral device and size information of video call data to be received from the selected peripheral device.

13. The user terminal device according to claim 12, wherein in response to the transmission method being determined as the streaming method, the control unit controls the communication unit to perform negotiation on the peripheral device so that session information for the determined streaming method is corresponding to session information with respect to the video call service between the user terminal device and the counterpart device.

14. The user terminal device according to claim 9, further comprising a display unit which displays a video call service screen including the video call data received from the selected peripheral device.
